(19) United States
(12) Patent Application Publication
(10) Pub. No.: US 2017/0096072 A1
(43) Pub. Date: Apr. 6, 2017

(54) INDUCTION MOTOR FOR A WORK MACHINE

(71) Applicant: Caterpillar Inc., Peoria, IL (US)

(72) Inventor: Kenneth Stonecipher, Metamora, IL (US)

(73) Assignee: CATERPILLAR INC., Peoria, IL (US)

(21) Appl. No.: 14/872,847

(22) Filed: Oct. 1, 2015

(51) Int. Cl. B60L 11/08; H02K 3/28; H02K 1/27; H02P 25/22

(52) U.S. Cl. CPC B60L 11/08; H02P 25/22; H02K 3/28; H02K 1/274

(57) ABSTRACT

A work machine may include a drive mechanically associated with a plurality of ground engaging elements. A 4-phase/4-sub-phase motor may be operatively associated with the drive and may include a stator, a rotor, and a 3-to-4 phase inverter. The stator may include a plurality of stator coils. The rotor may be operatively associated with the drive and may include a plurality of permanent magnets. The 3-to-4 phase inverter may be configured to provide alternating 4-phase and 4-sub-phase signals to the plurality of stator coils to produce magnetic flux with the plurality of permanent magnets to rotate the rotor.

### TECHNICAL FIELD

The present disclosure relates generally to induction motors and, more particularly, relates to an induction motor for a work machine.

### BACKGROUND

Some large work machines in the earthmoving, industrial, and agricultural industries require large torque density for overcoming large mass of such work machines when moving from start-up speeds to run speeds. In addition, large mining equipment such as, but not limited to, large mining trucks may also include a payload weight that significantly increases the total mass of the work machine requiring increased torque density to initialize movement from a stationary position. Often times these large work machines operate in off-road environments including uneven terrain such that quickly reaching the required torque density may facilitate efficiency and safety during operations.

Traditionally, such large work machines are equipped with 3-phase induction motors, also known as traction motors, to drive the wheels of the work machine. While effective, such 3-phase induction motors may occasionally experience phase errors causing brief interruptions to the rotation of the motor at run speeds.

U.S. Pat. No. 7,741,750 (the '750 patent) discloses an electric motor for use in electric road vehicles. The '750 patent discloses an electric motor designed to increase torque demands for 3-phase electric motors. While effective, the 3-phase electric motor of the '750 patent merely contemplates torque increases associated with road vehicles, having relatively less overall mass compared to significantly heavier large off-road work machines, and fails to address phasing errors that may be attendant with some 3-phase electric motors.

### SUMMARY

In accordance with an aspect of the disclosure, a work machine is provided. The work machine may include a drive mechanically associated with a plurality of ground engaging elements. A 4-phase/4-sub-phase motor may be operatively associated with the drive and may include a stator, a rotor, and a 3-to-4 phase inverter. The stator may include a plurality of stator coils. The rotor may be operatively associated with the drive and may include a plurality of permanent magnets. The 3-to-4 phase inverter may be configured to provide alternating 4-phase and 4-sub-phase signals to the plurality of stator coils to produce magnetic flux with the plurality of permanent magnets to rotate the rotor.

In accordance with another aspect of the disclosure, a 4-phase/4-sub-phase motor for a work machine is provided. The 4-phase/4-sub-phase motor may include a rotor encircled by and in operative association with a stator. A plurality of stator coils may be disposed on the stator with each stator coil radially arranged and evenly spaced apart from each other. A plurality of permanent magnets may be disposed on the rotor with each permanent magnet radially arranged and evenly spaced apart from each other. A 3-to-4 phase inverter may be in electrical communication with the plurality of stator coils and may be configured to provide alternating 4-phase and 4-sub-phase signals to the plurality of stator coils producing magnetic flux with the plurality of permanent magnets to rotate the rotor.

In accordance with yet another aspect of the disclosure, a method for achieving a desired torque density in a work machine is provided. The method may entail providing a 4-phase/4-sub-phase motor to drive a plurality of ground engaging elements of the work machine. Another step may be configuring a 3-to-4 phase inverter of the 4-phase/4-sub-phase motor to provide alternating 4-phase and 4-sub-phase signals to a plurality of stator coils of the 4-phase/4-sub-phase motor producing magnetic flux with a plurality of permanent magnets of the 4-phase/4-sub-phase motor to rotate a rotor of the 4-phase/4-sub-phase motor.

### BRIEF DESCRIPTION OF THE DRAWINGS

FIG. 1 is a perspective view of an exemplary work machine, in accordance with an embodiment of the present disclosure;

FIG. 2 is a schematic diagram illustrating a drive system of a work machine, in accordance with an embodiment of the present disclosure;

FIG. 3 is a simplified axial view of a motor, in accordance with an embodiment of the present disclosure;

FIG. 4 is a schematic diagram illustrating an exemplary modified Wye connection for a motor, in accordance with an embodiment of the present disclosure;

FIG. 5 is a diagram illustrating an exemplary magnetic flux distribution, in accordance with an embodiment of the present disclosure;

FIG. 6 is a chart mapping the relationship between time and RPMs of the motor, in accordance with an embodiment of the present disclosure, compared with a conventional 3-phase motor;

FIG. 7 is a chart mapping the relationship between speed over time and torque of the motor, in accordance with an embodiment of the present disclosure, compared with a conventional 3-phase motor; and

FIG. 8 is a flow chart illustrating a sample sequence of steps which may be practiced in accordance with an embodiment of the present disclosure.

### DETAILED DESCRIPTION

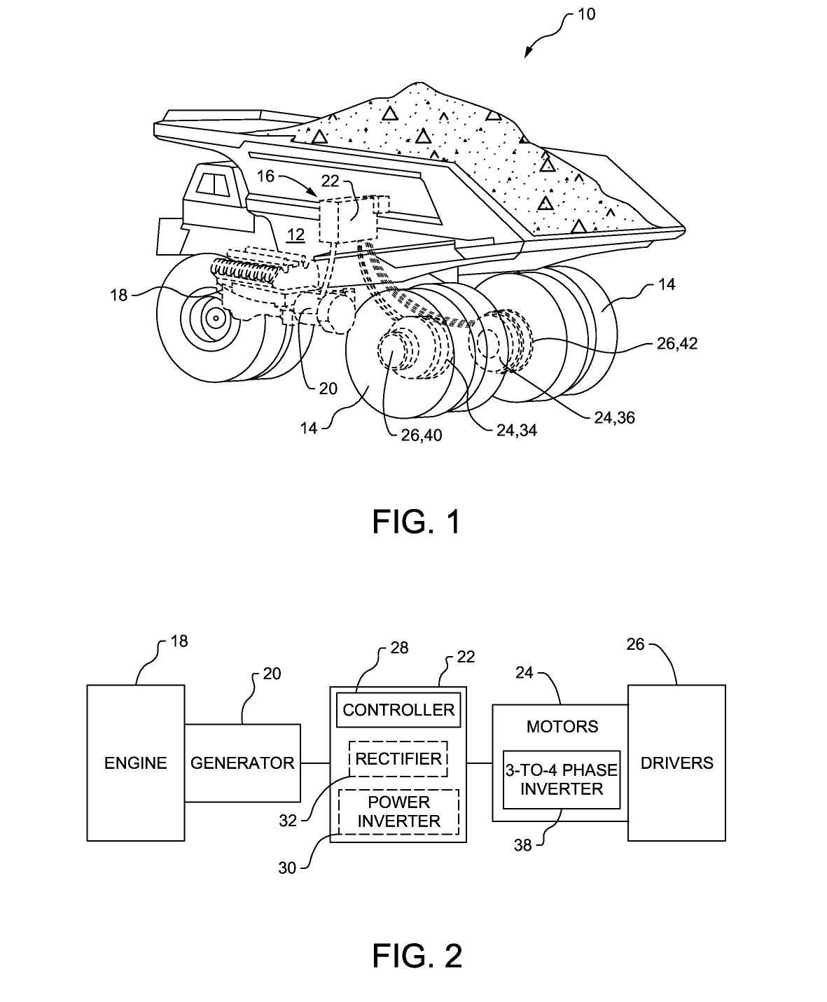

Referring now to FIG. 1, an exemplary work machine constructed in accordance with the present disclosure is generally referred to by reference numeral 10. While the work machine 10 is illustrated as a large mining truck, it is to be understood that the work machine may be any type of work machine well known in the earthmoving, industrial, and agricultural industries such as, but not limited to, excavators, motor graders, loaders, shovels, track-type tractors, pipelayers, compactors, dozers, scrapers, and the like. The work machine 10 may include a body 12 supported by a plurality of ground engaging elements 14. As non-limiting examples, the plurality of ground engaging elements 14 may be tires or tracks. The work machine 10 may also include a drive system 16, which is partially illustrated in phantom.

With reference to FIGS. 1 and 2, the drive system 16 may include an engine 18, a generator 20, a control system 22, a plurality of motors 24, and a plurality of drives 26. The engine 18 may be disposed in the body 12 and may supply power to the plurality of ground engaging elements 14. The engine 18 may be, but is not limited to, an internal combustion engine, a diesel engine, a natural gas engine, a hybrid engine, or any combination thereof. The engine 18 may be in mechanical association with the generator 20, which converts the mechanical energy produced from the engine 18 into electrical energy that is received by the control system 22. The generator 20 may generate direct current (DC). Alternatively, the generator 20 may be a traction alternator that produces alternating current (AC).

The control system 22 may include a controller 28, which may be any electronic controller or computing system including a processor which operates to perform operations, executes control algorithms, stores data retrieves data, gathers data, and/or performs any other computing or controlling task or function desired. The controller 28 may be a single controller or may include more than one controller configured to control various functions and/or features of the work machine 10. Functionality of the controller 28 may be implemented in hardware and/or software. As such, the controller 28 may include internal memory and/or the controller 28 may be otherwise connected to external memory, such as a database or server. The internal memory and/or external memory may include, but are not limited to including, one or more of read only memory (ROM), random access memory (RAM), a portable memory, and the like. Such memory media are examples of nontransitory memory media.

Furthermore, the control system 22 may include a power inverter 30 that is operatively associated with the controller 28. The power inverter 30 may be in electrical communication with and receive direct current from the generator 20 to convert into alternating current, which is provided to the plurality of motors 24. In an alternative embodiment, the control system 22 may further include a rectifier 32, also operatively associated with the controller, such that when the generator 20 is a traction alternator the rectifier 32, being in electrical communication therewith, receives and converts the alternating current from the traction alternator into direct current, some of which is received by the power inverter 30 for conversion back to alternating current, which is directed to the plurality of motors 24. The plurality of motors 24 may include a first motor 34 and a second motor 36, each of which may include a 3-to-4 phase inverter 38 in electrical communication with the power inverter 30 for receiving and converting the 3-phase alternating current signal from the power inverter 30 to 4-phase/4-sub-phase alternating current signals.

Both the first and the second motors 34, 36 may be mechanically associated with a first drive 40 and a second drive 42, respectively, of the plurality of drives 26. The first and second drives 40, 42, in turn, are mechanically associated with respective ground engaging elements of the plurality of ground engaging elements 14 via components such as, but not limited to, axles, gearboxes, and the like, to propel the work machine 10.

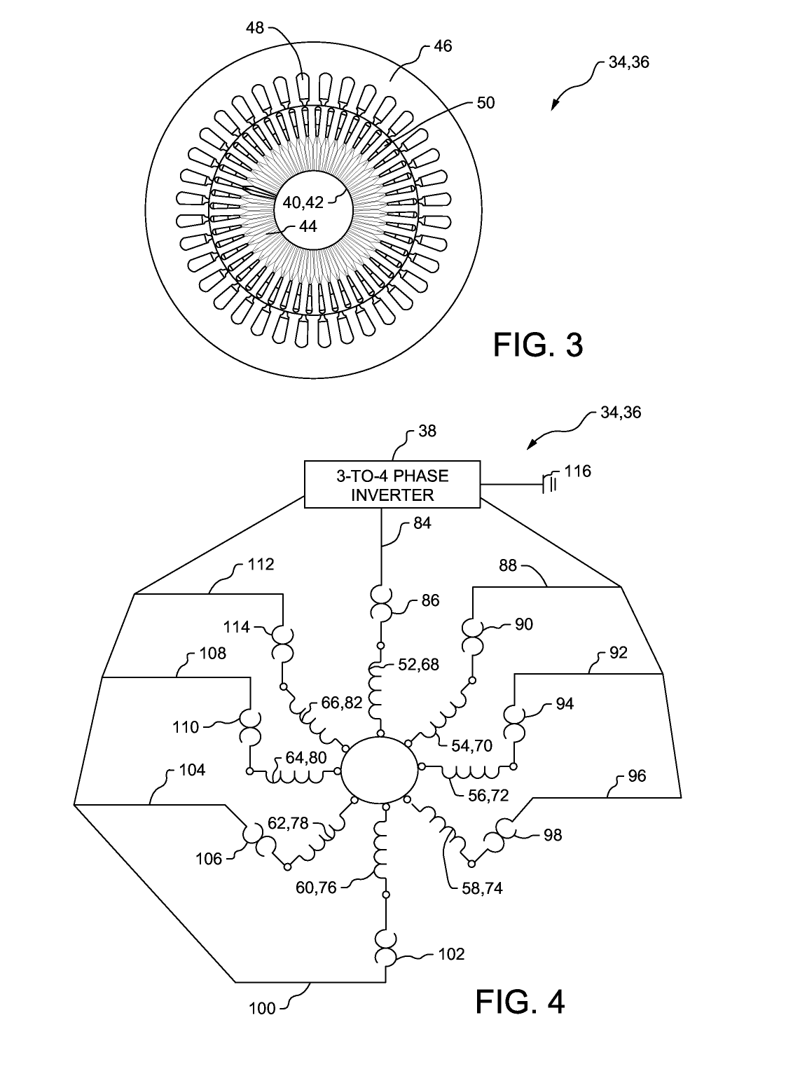

Moreover, both the first and the second motors 34, 36 may be an 8-phase induction traction motor or, more specifically, a 4-phase/4-sub-phase induction traction motor. However, it will be appreciated that other multi-phase motors may also be used. As illustrated in FIG. 3, both the first and the second motors 34, 36 may be similarly arranged and may include a rotor 44 such that each rotor 44 may be operatively coupled to the first and second drives 40, 42, respectively. The rotor 44 may be encircled by a stator 46. The stator 46 may include a plurality of stator coils 48 or windings disposed thereon with each stator coil 48 radially arranged and evenly spaced apart from each other. The rotor 44 may include a plurality of permanent magnets 50 disposed thereon with each permanent magnet 50 radially arranged and evenly spaced apart from each other. In an embodiment, the plurality of stator coils 48 may include thirty-six stator coils and the plurality of permanent magnets 50 may include forty-eight permanent magnets, although other numbers of stator coils and permanent magnets are certainly possible and with the scope of the present disclosure.

As illustrated in the modified Wye connection diagram of both the first and second motors 34, 36 of FIG. 4, the plurality of stator coils 48 are denoted as first through eighth grouped stator coils 52, 54, 56, 58, 60, 62, 64, 66. Each of the first through eighth grouped stator coils 52, 54, 56, 58, 60, 62, 64, 66 may be a grouping of individual stator coils of the plurality of stator coils 48 and are associated with a respective phase such that the first grouped stator coils 52 may be associated with a phase A 68; the second grouped stator coils 54 may be associated with a sub-phase A 70; the third grouped stator coils 56 may be associated with a phase B 72; the fourth grouped stator coils 58 may be associated with a sub-phase B 74; the fifth grouped stator coils 60 may be associated with a phase C 76; the sixth grouped stator coils 62 may be associated with a sub-phase C 78; the seventh grouped stator coils 64 may be associated with a phase D 80; and the eighth grouped stator coils 66 may be associated with a sub-phase D 82.

The first grouped stator coils 52 may be coupled to a first communication signal line 84 via a first breaker 86. The second grouped stator coils 54 may be couple to a second communication signal line 88 via a second breaker 90. The third grouped stator coils 56 may be coupled to a third communication signal line 92 via a third breaker 94. The fourth grouped stator coils 58 may be coupled to a fourth communication signal line 96 via a fourth breaker 98. The fifth grouped stator coils 60 may be coupled to a fifth communication signal line 100 via a fifth breaker 102. The sixth grouped stator coils 62 may be coupled to a sixth communication signal line 104 via a sixth breaker 106. The seventh grouped stator coils 64 may be coupled to a seventh communication signal line 108 via a seventh breaker 110. The eighth grouped stator coils 66 may be coupled to an eighth communication signal line 112 via an eighth breaker 114. Each of the first through eighth communication signal lines 84, 88, 92, 96, 100, 104, 108, 112 may be coupled to the 3-to-4 phase inverter 38, which is also coupled to ground 116.

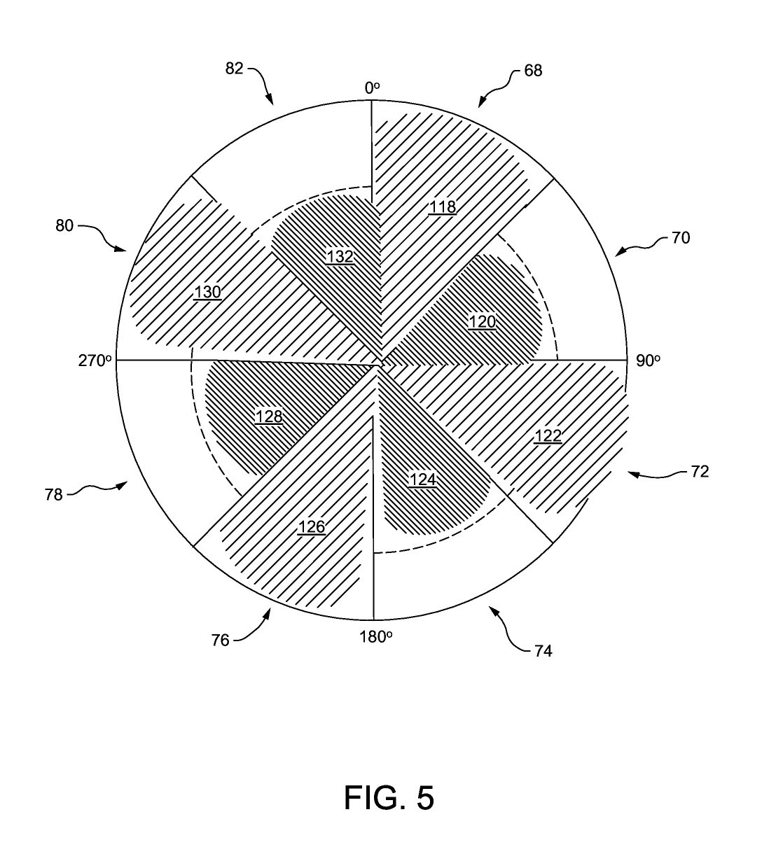

With reference to FIG. 5, a first stator flux space vector 118 may be produced to rotate the rotor 44 when the first grouped stator coils 52 receives the phase A 68 excitation signal at 0° from the 3-to-4 phase inverter 38; a second stator flux space vector 120 may be produced to rotate the rotor 44 when the second grouped stator coils 54 receives the sub-phase A 70 excitation signal at 45° from the 3-to-4 phase inverter 38; a third stator flux space vector 122 may be produced to rotate the rotor 44 when the third grouped stator coils 56 receives the phase B 72 excitation signal at 90° from the 3-to-4 phase inverter 38; a fourth stator flux space vector 124 may be produced to rotate the rotor 44 when the fourth grouped stator coils 58 receives the sub-phase B 74 excitation signal at 135° from the 3-to-4 phase inverter 38; a fifth stator flux space vector 126 may be produced to rotate the rotor 44 when the fifth grouped stator coils 60 receive the phase C 76 excitation signal at 180° from the 3-to-4 phase inverter 38; a sixth stator flux space vector 128 may be produced to rotate the rotor 44 when the sixth grouped stator coils 62 receive the sub-phase C 78 excitation signal at 225° from the 3-to-4 phase inverter 38; a seventh stator flux space vector 130 may be produced to rotate the rotor 44 when the seventh grouped stator coils 64 receive the phase D 80 excitation signal at 270° from the 3-to-4 phase inverter 38; and an eighth stator flux space vector 132 may be produced to rotate the rotor 44 when the eighth grouped stator coils 66 receive the sub-phase D 82 excitation signal at 315° from the 3-to-4 phase inverter 38.

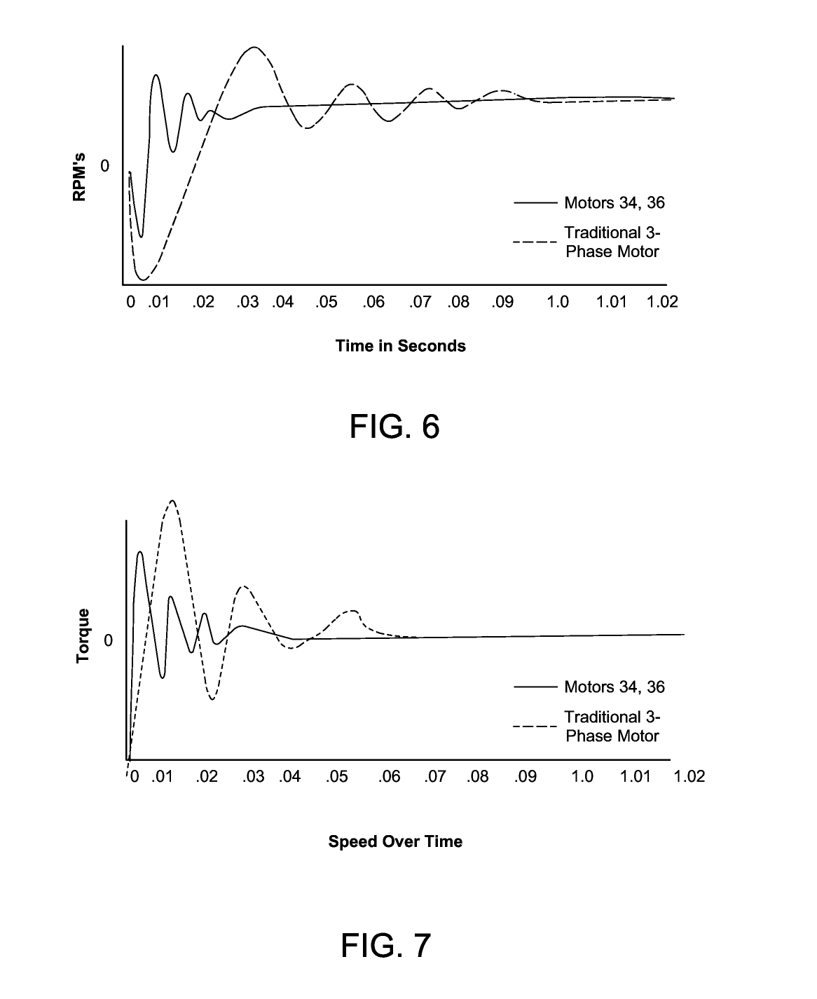

As illustrated in FIG. 6, the 4-phase/4-sub-phase first and second motors 34, 36 may reach peak RPMs in a quicker amount of time with greater stability than compared to a conventional 3-phase motor. Moreover, the 4-phase/4-sub-phase first and second motors 34, 36 may also reach peak torque density in a shorter amount of time, with respect to speed over time, as compared to a conventional 3-phase motor, as illustrated in FIG. 7.

### INDUSTRIAL APPLICABILITY

In operation, the present disclosure may find applicability in many industries including, but not limited to, earthmoving equipment and drive systems for same. As one detailed example, the work machine 10 may be a large mining truck, as illustrated in FIG. 1, that operates at an off-road work site and receives heavy payloads thereat. To navigate the off-road work site after receiving the heavy payload, the drive system 16 of the work machine 10 requires high torque density for the work machine 10 to travel from a stationary position. In particular, the generator 20 may convert the mechanical energy received from the engine 18 into direct current, which is passed to the power inverter 30 of the control system 22. Alternatively, the generator 20 may be a traction alternator that converts the mechanical energy received from the engine 18 into alternating current, which is passed to the rectifier 32 of the control system 22 to be converted to direct current that is received by the power inverter 30. The 3-to-4 phase inverter 38 receives the 3-phase pulsed current from the power inverter 30 to convert into a 4-phase/4-sub-phase pulsed current. For both of the first and the second motors 34, 36, the phase/sub-phase excitation signals 68, 70, 72,74,76, 78, 80, 82 of the pulsed current is provided to the first through eighth grouped stator coils 52, 54, 56, 58, 60, 62, 64, 66, respectively, producing alternating phase and sub-phase magnetic flux with the plurality of permanent magnets 50 of the rotor 44 of each motor 34, 36 causing each rotor 44 to rotate and drive the first and the second drives 40, 42, respectively, and, in turn, the plurality of ground engaging elements 14.

In such a manner, the first and the second motors 34, 36 may reach an increased torque density with less electrical power in a shorter amount of time such that the work machine 10 may move from a stationary position in a quicker amount of time. Moreover, the first and the second motors 34, 36 may include a more consistent magnetic flux, over conventional 3-phase motors, such that enhanced reduction of phase errors may be provided as a result of substantially continuous rotor rotation when at run speeds.

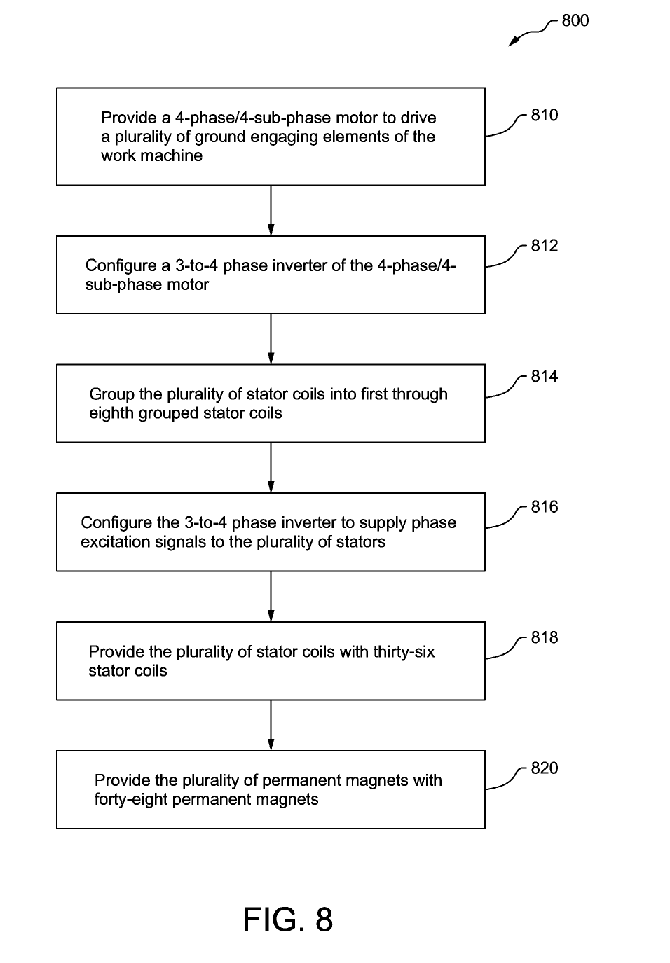

FIG. 8 illustrates a flow chart 800 of a sample sequence of steps which may be performed to achieve peak torque density in a time expedient manner in a work machine. Box 810 illustrates the step of providing a 4-phase/4-sub-phase motor to drive a plurality of ground engaging elements of the work machine. Another step, as illustrated in box 812, may be configuring a 3-to-4 phase inverter of the 4-phase/4-sub-phase motor to provide alternating 4-phase and 4-sub-phase signals to a plurality of stator coils of the 4-phase/4-sub-phase motor producing magnetic flux with a plurality of permanent magnets of the 4-phase/4-sub-phase motor to rotate a rotor of the 4-phase/4-sub-phase motor. A further step, as illustrated in box 814, may be grouping the plurality of stator coils into first through eighth grouped stator coils. Yet another step, as illustrated in box 816, may be configuring the 3-to-4 phase inverter to supply a phase A excitation signal to the first grouped stator coils, a sub-phase A excitation signal to the second grouped stator coils, a phase B excitation signal to the third grouped stator coils, a sub-phase B excitation signal to the fourth grouped stator coils, a phase C excitation signal to the fifth grouped stator coils, a sub-phase C excitation signal to the sixth grouped stator coils, a phase D excitation signal to the seventh grouped stator coils, and a sub-phase D excitation signal to the eighth grouped stator coils. Another step, as illustrated in box 818, may be providing the plurality of stator coils with thirty-six stator coils. An even further step, as illustrated in box 820, may be providing the plurality of permanent magnets with forty-eight permanent magnets.

What is claimed is:

1. A work machine, the work machine comprising:
a plurality of ground engaging elements;
a drive mechanically associated with the plurality of ground engaging elements; and
a 4-phase/4-sub-phase motor operatively associated with the drive, the 4-phase/4-sub-phase motor including a stator, a rotor, and a 3-to-4 phase inverter, the stator including a plurality of stator coils, the rotor operatively associated with the drive and including a plurality of permanent magnets, the 3-to-4 phase inverter configured to provide alternating 4-phase and 4-sub-phase signals to the plurality of stator coils producing magnetic flux with the plurality of permanent magnets to rotate the rotor.

2. The work machine of claim 1, further including an engine mechanically associated with a generator, the generator in electrical communication with a control system, the control system in electrical communication with the 3-to-4 phase inverter.

3. The work machine of claim 2, wherein the control system includes a power inverter in electrical communication with the generator and the 3-to-4 phase inverter, the power inverter configured to convert direct current received from the generator to 3-phase alternating current to supply the 3-to-4 phase inverter, the 3-to-4 phase inverter configured to convert the 3-phase alternating current to 4-phase/4-sub-phase alternating current signals.

4. The work machine of claim 2, wherein the control system includes a rectifier and a power inverter in electrical communication with the 3-to-4 phase inverter, the rectifier in electrical communication with the generator and the power inverter, the rectifier configured to convert alternating current received from the generator to direct current to supply the power inverter, the power inverter configured to convert the direct current received from the rectifier to 3-phase alternating current to supply the 3-to-4 phase inverter, the 3-to-4 phase inverter configured to convert the 3-phase alternating current to 4-phase/4-sub-phase alternating current signals.

5. The work machine of claim 1, wherein the plurality of stator coils includes thirty-six stator coils.

6. The work machine of claim 1, wherein the plurality of permanent magnets includes forty-eight permanent magnets.

7. The work machine of claim 1, wherein the plurality of stator coils are grouped into first through eighth grouped stator coils.

8. The work machine of claim 7, wherein the first grouped stator coils is associated with a phase A, the second grouped stator coils is associated with a sub-phase A, the third grouped stator coils is associated with a phase B, the fourth grouped stator coils is associated with a sub-phase B, the fifth grouped stator coils is associated with a phase C, the sixth grouped stator coils is associated with a sub-phase C, the seventh grouped stator coils is associated with a phase D, and the eighth grouped stator coils is associated with a sub-phase D.

9. The work machine of claim 8, wherein the phase A excitation signal is at 0°, the sub-phase A excitation signal is at 45°, the phase B excitation signal is at 90°, the sub-phase B excitation signal is at 135°, the phase C excitation signal is at 180°, the sub-phase excitation signal is at 225°, the phase D excitation signal is at 270°, and the sub-phase D excitation signal is at 315°.

10. A 4-phase/4-sub-phase motor for a work machine, the 4-phase/4-sub-phase motor comprising:
a stator;
a rotor encircled by and in operative association with the stator;
a plurality of stator coils disposed on the stator, each stator coil radially arranged and evenly spaced apart from each other;
a plurality of permanent magnets disposed on the rotor, each permanent magnet radially arranged and evenly spaced apart from each other; and
a 3-to-4 phase inverter in electrical communication with the plurality of stator coils and configured to provide alternating 4-phase and 4-sub-phase signals to the plurality of stator coils producing magnetic flux with the plurality of permanent magnets to rotate the rotor.

11. The 4-phase/4-sub-phase motor of claim 10, wherein the plurality of stator coils are grouped into first through eighth grouped stator coils.

12. The 4-phase/4-sub-phase motor of claim 11, wherein the first grouped stator coils is associated with a phase A, the second grouped stator coils is associated with a sub-phase A, the third grouped stator coils is associated with a phase B, the fourth grouped stator coils is associated with a sub-phase B, the fifth grouped stator coils is associated with a phase C, the sixth grouped stator coils is associated with a sub-phase C, the seventh grouped stator coils is associated with a phase D, and the eighth grouped stator coils is associated with a sub-phase D.

13. The 4-phase/4-sub-phase motor of claim 12, wherein the phase A excitation signal is at 0°, the sub-phase A excitation signal is at 45°, the phase B excitation signal is at 90°, the sub-phase B excitation signal is at 135°, the phase C excitation signal is at 180°, the sub-phase excitation signal is at 225°, the phase D excitation signal is at 270°, and the sub-phase D excitation signal is at 315°.

14. The 4-phase/4-sub-phase motor of claim 10, wherein the plurality of stator coils includes thirty-six stator coils.

15. The 4-phase/4-sub-phase motor of claim 10, wherein the plurality of permanent magnets includes forty-eight permanent magnets.

16. A method for achieving a desired torque density in a work machine, the method comprising:
providing a 4-phase/4-sub-phase motor to drive a plurality of ground engaging elements of the work machine; and
configuring a 3-to-4 phase inverter of the 4-phase/4-sub-phase motor to provide alternating 4-phase and 4-sub-phase signals to a plurality of stator coils of the 4-phase/4-sub-phase motor producing magnetic flux with a plurality of permanent magnets of the 4-phase/4-sub-phase motor to rotate a rotor of the 4-phase/4-sub-phase motor.

17. The method of claim 16, further including grouping the plurality of stator coils into first through eighth grouped stator coils.

18. The method of claim 17, further including configuring the 3-to-4 phase inverter to supply a phase A excitation signal to the first grouped stator coils, a sub-phase A excitation signal to the second grouped stator coils, a phase B excitation signal to the third grouped stator coils, a sub-phase B excitation signal to the fourth grouped stator coils, a phase C excitation signal to the fifth grouped stator coils, a sub-phase C excitation signal to the sixth grouped stator coils, a phase D excitation signal to the seventh grouped stator coils, and a sub-phase D excitation signal to the eighth grouped stator coils.

19. The method of claim 16, further including providing the plurality of stator coils with thirty-six stator coils.

20. The method of claim 19, further including providing the plurality of permanent magnets with forty-eight permanent magnets.
